(19) United States
(12) Patent Application Publication
(10) Pub. No.: US 2011/0288900 A1
(43) Pub. Date: Nov. 24, 2011

(54) Scheduling Management System, Method and Device

(75) Inventors: Geoff McQueen, Tarrawanna (AU); Hugh Cowling, Figtree (AU); Christine Higgins, Milwaukee, WI (US); Eamonn Bell, Wollongong (AU); Glenn Fowler, Coniston (AU)

(73) Assignee: EHIIVE HOLDINGS PTY LTD, Wollongong (AU)

(21) Appl. No.: 13/113,106

(22) Filed: May 23, 2011

(30) Foreign Application Priority Data
May 24, 2010 (AU) 2010902295
Aug. 16, 2010 (AU) 2010212367

(51) Int. Cl. G06Q 10/00

(52) U.S. Cl. 705/7.16; 705/7.13; 705/7.21

(57) ABSTRACT

The present invention relates generally to the field of task management methods and systems and specifically task management methods and systems for creating and optimising future schedules utilising the computer.

### INTRODUCTION

The present invention relates generally to the field of task management methods and systems and specifically task management methods and systems for creating and optimising future schedules utilising the computer.

### BACKGROUND

Current task management systems and tools have computer executed features including the means to create lists of tasks, sub-tasks, notes, and tags on to-do items, along with the means to share tasks with others, embed them in a public or private web page, and to move items around in priority. However, such task allocation and monitoring systems and methods are static, requiring data to be entered and updated manually, with limited ability to take into account variables that affect the actual performance and management of tasks=(e.g. interruptions, underestimating work required, time liaising with a team or manager to discuss work issues, time spent on other work-related tasks not allocated as part of a time “budget” available to work on scheduled tasks). Further such task allocation and monitoring systems and methods lack the critical attribute of smart or “optimised” interpretation of the task management.

Task management systems and methods may divide a task into sub-tasks and sort the subtask(s) according to their specific resource requirement(s) and the availability of resources. Task management for a particular job per unit of time is referred to as a “task management scheduling” or “scheduling”.

Usually scheduling will divide tasks depending on the date such as the following:

1) Overdue tasks which have a scheduled date preceding today's date;

2) Immediately due tasks (today);

3) Pending tasks (due in the near future); and

4) Future tasks (all tasks as scheduled).

However, this scheduling of tasks is a mere calendar listing of all events due. Specifically, to date this is only a poor mechanism for the allocation of tasks when taking into account human failings in task management.

Humans Estimate Time Poorly

Task management was initially analysed using “wrench time” around AD1910 for production assembly workers to measure what percentage of a worker's time is spent on actual work. Typically these “wrench time” studies found that people spend 25 to 35 percent of their time working. The wrench time studies were found to be poor business management tools for various reasons including the finding that people are very poor at estimating how long a task will take.

Studies performed on the relationship between:

1. task and time management practices, and

2. estimates of task duration,

have found that those who perceive themselves as good time managers tend to not to be able to estimate time passing.

For example, “Evidence for people being able to predict duration times accurately in advance appears . . . to be inconsistent”. Buehler, Griffin and Ross (1994) suggest people consistently under estimate project duration times, whereas Burt and Kemp (1994) showed subjects generally overestimated project duration.

These opposite findings are due to the above studies addressing different time-scales:

1. days to weeks are under estimated: Buehler et al. (1994); whereas

2. minutes are over estimated: Burt and Kemp (1994).

Individuals also are overly confident that one's own project will proceed as planned, even while knowing that the vast majority of similar projects have run late. Therefore, the estimation made by individuals is a belief which leads to poor time scheduling.

Additionally, schedules do not reflect actual time spent. For example, a meeting is planned for a specific period of time because it fits into the units of the schedule and does not reflect the time needed. For example a meeting may be scheduled for an hour but really needs 70 minutes and so runs late, whereas other tasks take 23 minutes on average but constantly get scheduled for 20 minutes, so the scheduling of the time required is consequently an under estimate. Thus, the planned time and resource allocation schedule is not adhered to because they are not accurate.

Individuals also often estimate time using their memory, which via studies, has been a very poor time estimator when it comes down to exact quantitative estimates. There have been practices as rule of thumb as taught in industry such as estimate how long the task will task will take and multiply that estimate by 2.5 times.

The inability to judge how long a task will take is a universal problem. Psychologists refer to this as inability to estimate as the planning fallacy.

Studies show that the planning fallacy is attributed to inherent biases we have when estimating how long a task will take to do—no matter what the task is, we:

1) fail to view objectively past experiences when planning our future;

2) ignore the actuality that things do not go as planned—we cannot read the future so our plans tend to be “best-case scenarios”; and

3) cannot think about all the subtasks that make up the task, and consider how long each subtask will take.

The influence of these biases are also variable between people: individuals in positions of power are particularly poor at judging time required, because powerful people focus on getting what they want, more than acknowledging the time and potential obstacles that stand in their way.

Task reports which use the user's estimates of the task alone, when scheduling tasks and subtasks on a time and/or calendar basis have consistent and significant problems due to the reliance on human estimates of task duration and planning which underpin the scheduling.

Therefore, there is a need for task management with optimised scheduling of one or more tasks based on actual performance. We refer to this as task optimisation.

Task Management Information Available at Allocation

The majority of task management systems use:
1. task scheduling, which is the main means of task management to date. This takes the form of a list of tasks allocated to a calendar, which gives poor future scheduling of the tasks and often is used for as a list without the reliance on the time allocated. Also, adapting to change in a schedule of tasks due to delays in completing tasks or the introduction of previously unscheduled tasks is very difficult, and often results in the progressive schedule being abandoned;

Other forms of task management systems are implemented by:
2. allocation of time and/or resources available so that they are negotiated around a schedule so as to improve their placement. This is a very time consuming method of managing tasks and used mainly in project management scenarios. Also such as method often fails when a task or sub-task fails to be contained in it scheduled time or another unscheduled tasks become apparent;
3. forward allocations of tasks—where the project's outcomes are specified before scheduling to provide the task management to specifically meet an outcome at an agreed time by back propagation of resources available at a specific times; and lastly
4. allocation of tasks directly to the task manager so the next task allocation will not be allocated until the task precedent has been performed. Therefore, the dynamic allocation of tasks can be scheduled on a “just in time” basis.

Further, a combination of method of task allocation methods above can be used.

Problems with Task Management Optimisation Information

Problems with reliance on current task management methods, systems and tools include:

1) specific resource requirement(s) and the availability of such resources are not highlighted to resource manager(s) when they are undertaking the activity of forward scheduling;

2) weighting by a user on the time and resources required for a particular task(s) and/or subtasks has considerable variance and is not reflected on the true time or resources required; and

3) non-uniformity between different users of known task management systems and methods produces variable results often resulting in, for example, a manager allocating tasks to be performed with the same allocation for all individuals, which in reality there is no “one size fits all” approach; and

4) users find it difficult to update or re-estimate the time a given task will take to complete in a way that the resource manager(s) are able use this updated information in their activity forward scheduling. This issue increases in importance as the granularity of the tasks being managed becomes more fine-grained and as the number of users increases

A Need for an Improved Method to Collect and Communicate Task Management Scheduling Information

There is a need for a better way to calculate and communicate (make accessible) tasks and scheduling across a number of people (e.g. a team, department, entire businesses). Having accurate estimates of tasks and schedules is critically important for any business/organisation that depends on human resources, especially service industries and professional services industries.

Therefore, there is a need for an improved method, system and tool for task data and communicating (making accessible) task schedules as obtained through task management software.

Attempts to Overcome the Problems of Measuring Tasks

In recent times, there has been interest in developing automated analytic technologies for determining an objective with assessment of the tasks required to meet the objective and the resources available.

However, problems with this technology include:
1) access to the technology and to the assessment—the complexity of such systems often excludes many participants;
2) the need for pre-preparation of the tasks by a project manager to enable the scheduling of the tasks through pre-sorting, assessing and appraising the tasks before placing the tasks into task management systems/tools; and
3) the task management methods, systems and tools need to operate under project management conditions and not within the broad range of scheduling conditions that exist in real life—“bump this”, “move that”, “did we consider this”. These are often the unmeasured aspects of tasks and projects that need to be reviewed and performed on a regular basis. Any technology that assumes the project will progress completely as expected will at very least suffer user skepticism, and more likely will be abandoned by users as the technology does not help them in scheduling their work.

Another example of this automated task management analysis technology measures resources competed per unit of time, mean performance, resource strengths, task size versus performance output et cetera.

In order to have a task scheduler that is accurate, there is a whole lot of information that needs to be constantly entered and updated. This presents a problem for current systems with their focus on data input and calendars for scheduling, as they do not provide granularity and accuracy to enable automated task management—either the information is not entered or it is not updated and therefore the data remains static and does not account for factors that can affect scheduling.

Task schedulers currently have problems with:
1. dynamically updating a schedule in a timely manner; and
2. capturing more accurately the time taken to perform tasks (and hence also capturing task over flow).

Therefore, these solutions cannot provide added requirements such as priority assessment of task allocation readily available to a user or colleagues when and where required.

There is a need for a specific resource requirement(s) availability for:
a) task data information from a priority assessment of tasks performed as obtained through scheduling by a task management method, system and tool performing a scheduling examination of task management in a tangible, reliable form; and
b) communicating (making accessible) the priority assessment information, along with objective optimisation data to user on demand so that the information from the priority assessment is available where and when it is required by a user.

It would be useful if the task management's specific resource requirement(s) availability information were accessible to the task management project participant(s) on demand.

It is an object of the present invention to provide a task schedule that provides a solution to the problem of task management on estimates by users undertaking the tasks of time requirements, recognizing the inherent planning fallacy problems and providing resource manager(s) with information based on the accuracy of previous estimates by a user to enable the resource manager(s) to dynamically reconcile and adjust for planning fallacy inherent in human nature, based on an algorithm which uses quantitative historical data.

### SUMMARY

According to an aspect of the invention there is provided a task management method including the steps of:
a) collecting task information including the following:

(i) task requirements including one or more of the following:
i. time;
ii. resource,
iii. priority;
iv. policy;
v. rules;
vi. workflow;
vii. dependency;
   wherein said task requirements define said task; and
   (ii) metadata including one or more of the following:
i. task name(s);
ii. task goal;
   wherein said metadata describes said task; and
b) building one or more task objects from said task requirements and associated metadata;
c) analysis of said task requirement data performed by one or more of the following:
   (a) subjective estimates such that said task requirement data are entered as estimates by one or more users as associated with said metadata as subjectively acceptable to said user(s); and
   (b) an objective evaluation performed through making an objective comparison(s) with one or more of the following:
   a. past task information collection means such that past task requirement data are compared with like unfulfilled task requirement data;
   b. a user's behavioural file(s) such that a user's behaviour is enabled to be compared with completed task requirement data;
   c. behavioural algorithm output(s) wherein task object fulfillment is extrapolated from a user's behavioural file(s); and/or
   d. normalised group data of like task information collection means wherein the application of said normalised group data is compared with like subjective task information collection means; and
   such that said task information collection means is objectively evaluated against historic, external and/or extrapolated task information collection means; and
   (d) scheduling said task objects by each task object's requirement wherein a task schedule is reported via a user interface.

According to another aspect of the invention there is provided a task management tool comprising:

a) a task information collection means including the following:
(i) task requirement data including one or more of the following:
i. time;
ii. resource,
iii. priority;
iv. policy;
v. rules;
vi. workflow;
vii. dependency;
   wherein said task requirement data define said task; and
(ii) metadata including one or more of the following:
i. task name(s);
ii. task goal;
   wherein said metadata describes said task; and

b) task objects built from said task requirement data and associated metadata;

c) subjective and objective requirement data as analysed by one or more of the following:
(a) subjective estimates such that said task requirement data are entered as estimates by one or more users as associated with said metadata as subjectively acceptable to said user(s); and
(b) an objective evaluation performed through making an objective comparison(s) with one or more of the following:
a. past task information collection means such that past task requirement data are compared with like unfulfilled task requirement data;
b. a user's behavioural file(s) such that a user's behaviour is enabled to be compared with completed task requirement data;
c. behavioural algorithm output(s) wherein task object fulfillment is extrapolated from a user's behavioural file(s) ; and/or
d. normalised group data of like task information collection means wherein the application of said normalised group data is compared with like subjective task information collection means; and

such that said task information collection means is objectively evaluated against historic, external and/or extrapolated task information collection means; and

d) task objects schedule sort by each task object's requirement data wherein task schedule is reported via said user interface.

The invention thus provides a new or alternative task management method, system and tool that overcomes the problem of subjective task management or inadequate or inaccurate task information with regard to the task requirements as collected, allocated and scheduled subjectively by a user or team by providing means to access to data that fits between the extremes of above and makes accessible such information so that it can be readily accessed, ascertained, and, when required adjusted when and where a user wants to rely on it.

This task management method, system and tool also provides a feedback and a feed-forward system to bring in line user determined subjective schedules with automated objective schedules so the user can appreciate the differences between the two and make informed decisions on whether or not and how to realign the schedule taking into account optimised information.

This task management method, system and tool further provides a means to access information and to communicate (make accessible) such information, including on demand when and where a user wants to rely on it.

In one embodiment, the task management system provides task allocation information software so that as much relevant information about the value-determining characteristics of resource allocation can be readily accessed by a user on demand.

Although described with reference to specific embodiments, one skilled in the art could apply the principles discussed herein to other areas and/or embodiments.

For a better understanding of the invention and to show how it may be performed, a preferred embodiment will now be described, by way of non-limiting example only, with reference to the accompanying drawings.

### BRIEF DESCRIPTION OF THE DRAWINGS

Preferred embodiments of the invention are described with reference to the accompanying drawings, wherein like reference numerals refer to like features, and in which:

FIG. 1 is a diagrammatic representation of the task management method, system and tool incorporated as a “Software as a Service”, Information as a Service and a Platform as a Service delivery system;

FIG. 2 is a diagrammatic representation of Software as a Service of the Task Information Collection and transmission means;

FIG. 3 is a flow chart of one embodiment of the task management method;

FIG. 4 is an exemplary task optimisation display;

FIG. 5 is an exemplary user Task Object list and schedule as a histogram of future task assignment scheduled and the allocations contained within each schedule;

FIG. 6 is an illustration of a task re-allocation system as a drag and drop task to-do item placed into a preferred order;

FIG. 7 is an exemplary user interface of the task re-scheduling criteria available for re-allocation/exchange to optimise scheduling;

FIG. 8 is a sample task management for viewing in different time epochs;

FIG. 9 is an illustration of task Optimisation with a trend line for review of assigned task workload; and

FIG. 10 is an illustration of a filtered task list revealing the priority and dependency of tasks and subtasks.

### DETAILED DESCRIPTION

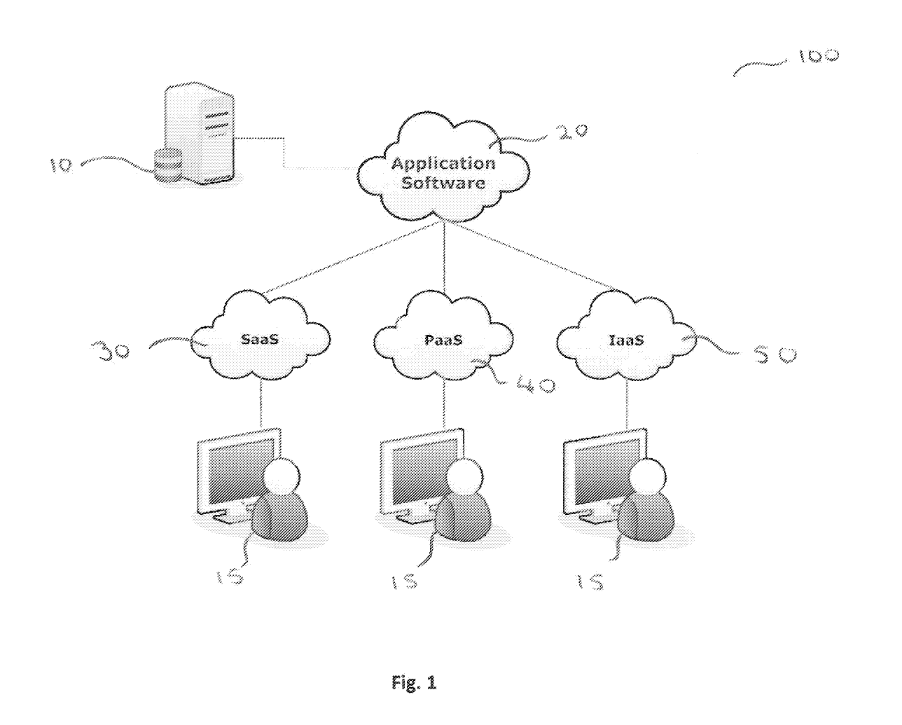

Referring to FIG. 1, a preferred embodiment of the task management method, system and tool 100 comprises database 10 which communicates data in response to user(s) 15 request via application software 20 via a “Software as a Service” (SaaS) 30 delivery model. The task management method, system and tool 100 is also able to be delivered as an Information as a Service (IaaS) 40 within another application such as an Enterprise resource Planning (ERP) system or expanded to be provided as a Platform as a Service (PaaS) 50 such that the user's receiving device acts as a terminal window.

Task Information Collection (TIC) may take place via a database (or flat file or other means) stored on a computer or a computer network so as to be accessible remotely (e.g. over the Internet or through the cloud) by a user.

The TIC collecting task information pertaining to:
1. task requirements including time/resource schedules, priority, policy/rules, workflow and/or dependency requirements; and/or
2. task data including metadata, task name(s) and/or task goal(s).

Task data for example can lists of tasks to be performed, including subtasks and descriptors of all tasks and subtasks. The descriptors can be industry-based or workplace/organization specific. There is a thesaurus to normalise task data into a common task name and goal, since a task and a goal can come under a variety of terms. For example, the name “go to the bank” can also be termed “get some money” “get petty cash reimbursed” et cetera. Here goals and task can be confused and therefore the thesaurus can check name and/or goals to normalize the task data. This normalisation of task data can occur automatically or via task naming pick lists, task selection wheels or via a variety of other means. This normalisation allows like or similar tasks can be associated by their task data including their metadata, task name(s) and/or task goal(s).

In one embodiment the adjustment time/resources, priority, policy/rules, workflow and/or dependency requirements are enabled so that the addition, subtraction and/or change in level of a requirement are enabled. For example, this adjustment can be performed by a user, where on reflection, the allocation of time is too low so that the user allocates further time to the task requirement; however, the resources available may be too high and therefore the subtraction of resources is enabled. Likewise the priority many be changed to a lower or higher level as circumstances change.

Population of one or more said task requirements is also enabled such that when an allocation of one requirement is made without allocation of other mandatory requirements then there are assumed allocation or other requirements made. For example, if an allocation of two hours is made without specifying resources, then a resource of one person for two hours is allocated. This population of requirements overcomes gaps which may exist in a collection of task requirements.

The population of absent requirements allows normalisation of task requirement to take place so like tasks in the form of task requirements, task objects and even task schedules is enabled in some embodiments. This normalisation of task requirements to be associated with other specified task requirements allows task information to me adapted to personnel, group or project needs. For example, if “shopping for food” specifies two hours of time then one person is allocated as the resource; however, the resource may require personnel adjustments such as when Joe does the shopping it take three hours but when Robyn does it then the shopping only takes ninety minutes. Normalisation of requirements takes the spread of known activity and applies it to the individual's performance such that a specific user may be within one standard deviation of the mean and closely associated with the mode time taken when “shopping for food”.

The adjustability, population and normalisation of task requirements are enabled to be performed:
a) subjectively, so that the user can align task requirements with their perceived requirements; and/or
b) objectively, so that a task management application can align task requirements with:
i. past tasks requirement(s);
ii. said user's behavioural file(s) relating to task requirement(s);
iii. behavioural algorithm output(s) of task requirement(s); and/or
iv. normalised group task requirement data;

This adjustability, population and normalisation of task requirements are also enabled for task objects.

The analysis of one or more said task objects is enabled by performing:
i. a subjective estimate by a user, such that said task object as associated with said task name and/or said task goal is subjectively acceptable to said user; and
ii. an objective estimate performed through making an objective comparison(s) with one or more of the following:
a) past tasks such that past task object(s) requirements are enabled to be compared with unfulfilled task objects;
b) a user's behavioural file(s) such that a user's behaviour is enabled to be compared with task object(s) fulfillment requirements;
c) behavioural algorithm output(s) wherein task object fulfillment is extrapolated from said user's said behavioural file(s); and/or
d) normalised group data of like task object fulfillment wherein the application of said data normalised group is compared with subjective task objects;

such that said task object as associated with said task name and/or said task goal is objectively compared to historic, external and/or extrapolated task information;

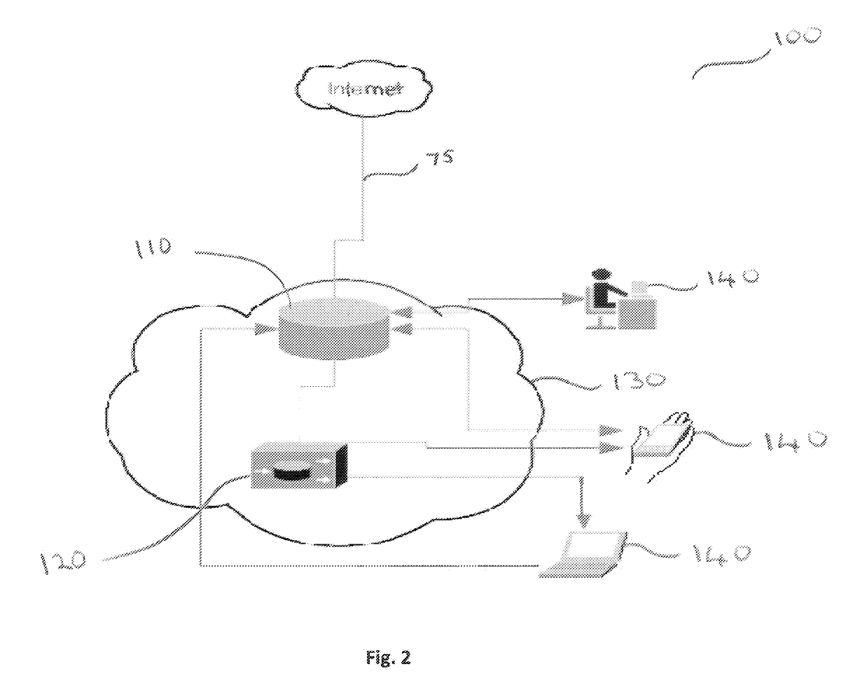

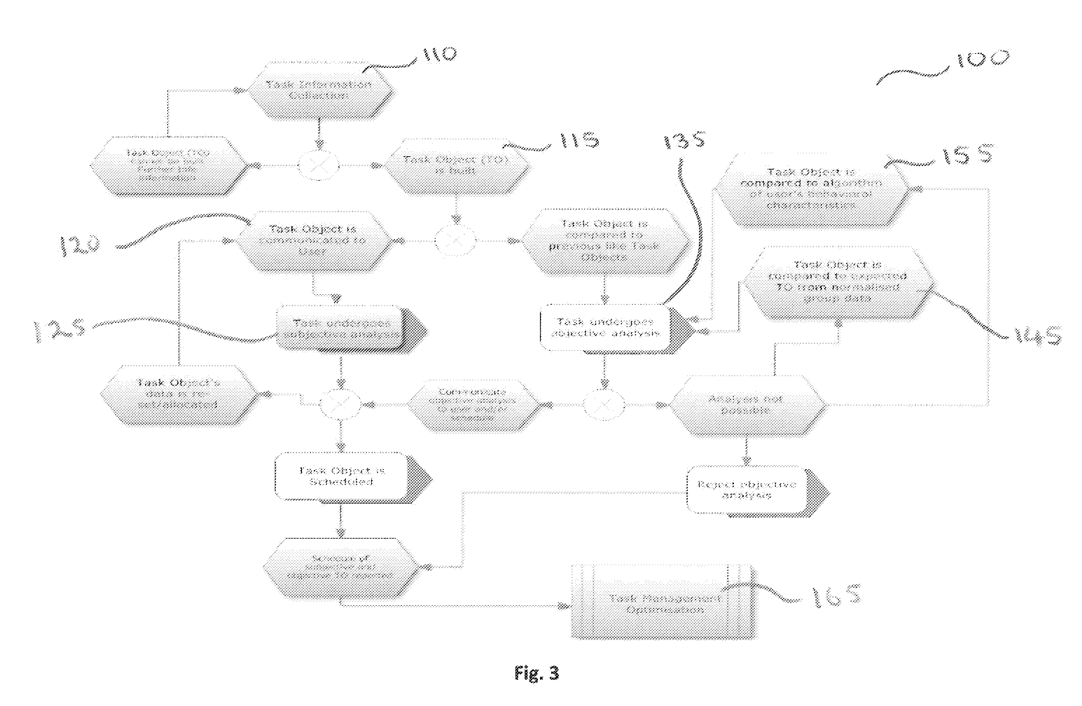

Referring to FIG. 2, a further embodiment of the task management method, system and tool 100 and FIG. 3 showing a flow chart of the of the task management method, there is:
(a) Task Information Collection (TIC) 110 collects and stores task-and scheduling-related information;
(b) a Task Object (TO) 115 is built from the information collected and other information that is associated with that task. A TO is built from explicit information provided by the task builder and by inferred information contained within the TIC such that the appropriate resources can be allocated even though the resources may not have been specified;
(c) a Task Object Communication (TOC) 120 to enable communication of a task object which contains task- and scheduling-related information across a network (including the internet) 130 to one or more computers 140, including a mobile computing device, a personal digital assistant, a smart phone, a computer, a server, or any other device with processing capacity);
(d) analysis of:
a) task, time and resource collection, allocation and scheduling data as entered subjectively 125 by a user;
b) the scheduling of tasks and their associated time and resources based on:
a. user subjectively determined priority and other criteria; and/or
b. objective analysis 135 based on:
   i. past task completion data; and/or
   ii. normalised group data 145 from groups of individuals doing like tasks with similar skillsets;
      obtained from sources such as log files, timesheets, activity files and the like with records of previous tasks performed and the time associated with performing these tasks;
c) means to generate task completion algorithms 155 based on task completion analysis obtained from past task completion data to manage the tasks as allocated and/or (re)scheduled such that these algorithms objectively build task schedules, and
d) Task Management Optimisation 165 through the user's observation of the difference between subjective and objective task schedules as displayed with the optimised schedule containing both the:
   a. subjective user estimated task allocation, superimposed on
   b. objective scheduling of task, time and resources.

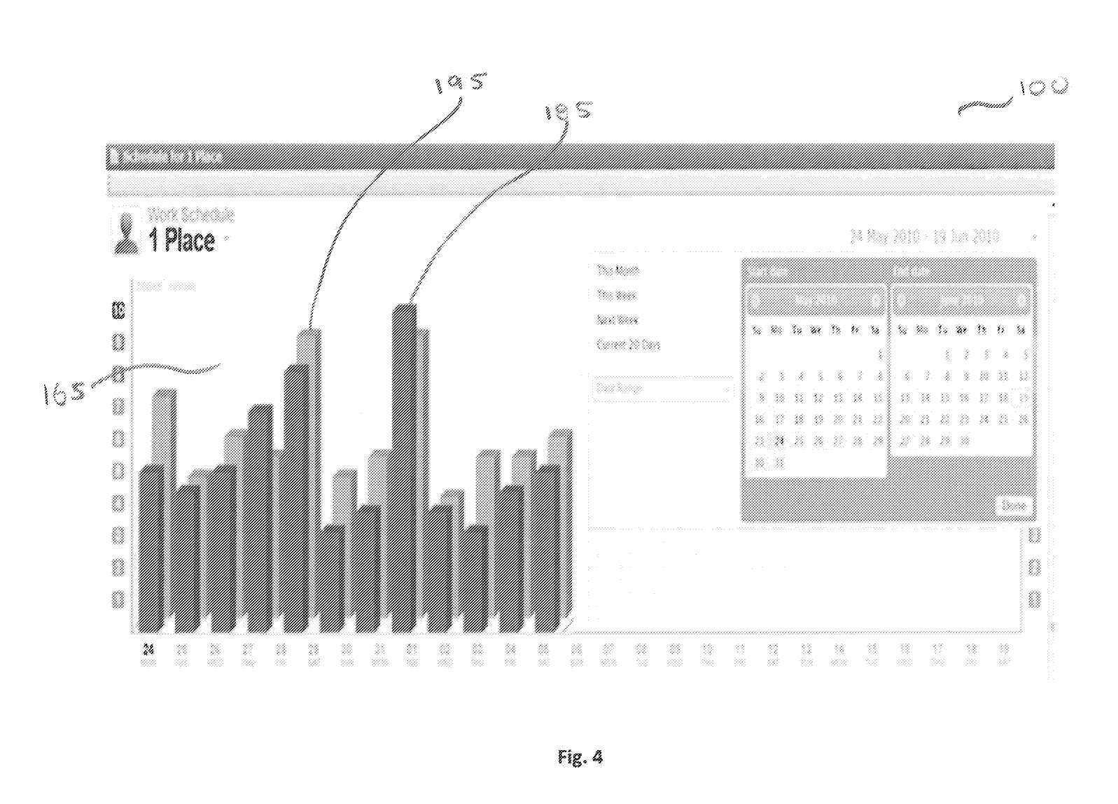

FIG. 4 shows an example of a task management optimisation 165 output which is the comparison between task objects (TO):
i. subjectively scheduled 185 (the darker columns), compared to
ii. objectively scheduled 195 (the lighter columns).

This provides both:

a) feedback to the user on how close are they estimating current task schedules compared to objective performance criteria obtained from task completion criteria; and

b) feed-forward information to the user as to historical data is feed forward into new and future schedules to optimise the difference from subjective and objective schedule generation.

This Task Management Optimisation also provides a means to model schedules to estimate performance and deadlines by observing the difference in task management when optimising the output such that risk parameters may be incorporated.

Tasks are hereafter described as containing the following steps:
1. Task Information Collection—the entry of Tasks and their related descriptors;
2. Task Object, which is built from Task Information Collection plus the addition of further information including:
   a. sliding the time axis for a task to increase its time allocated; and/or
   b. allocating different resources to Task Information such that it will be divided into two or more Task Objects; and
3. Task Schedule—the order and timing that the tasks will be performed which is reported individual(s) and project participant(s) to know their task(s) allocation, priority(s) and/or scheduling of resources.
4. There are two task schedules generated:
   a. a first schedule is generated from the user's perspective (subjective) as ascertained from the task data expectations of completion as generated from the Task collection step; followed by
   b. a second schedule generated from an objective perspective based on historical data relating to task completion times. This schedule is generated by comparing:
      i. task completion times, to
      ii. expected completion times
         such that a time loading is added to task collection expected completion times. This results in a schedule being produced that is distinct to the first schedule.
5. Task Management Optimisation

(Optimisation) is the comparison of the two schedules generated so the user can tweak their expectations based on the difference in the schedules. This results in a more accurate schedule being produced by highlighting the planning fallacy in the user's expected completion times set in the first schedule.

Task Information Collection

Tasks are variable in terms of time and resources, for example, some tasks are:

1. dependent on rarer resources;

2. dependent on other events to precede them; and/or

3. time and expertise consuming.

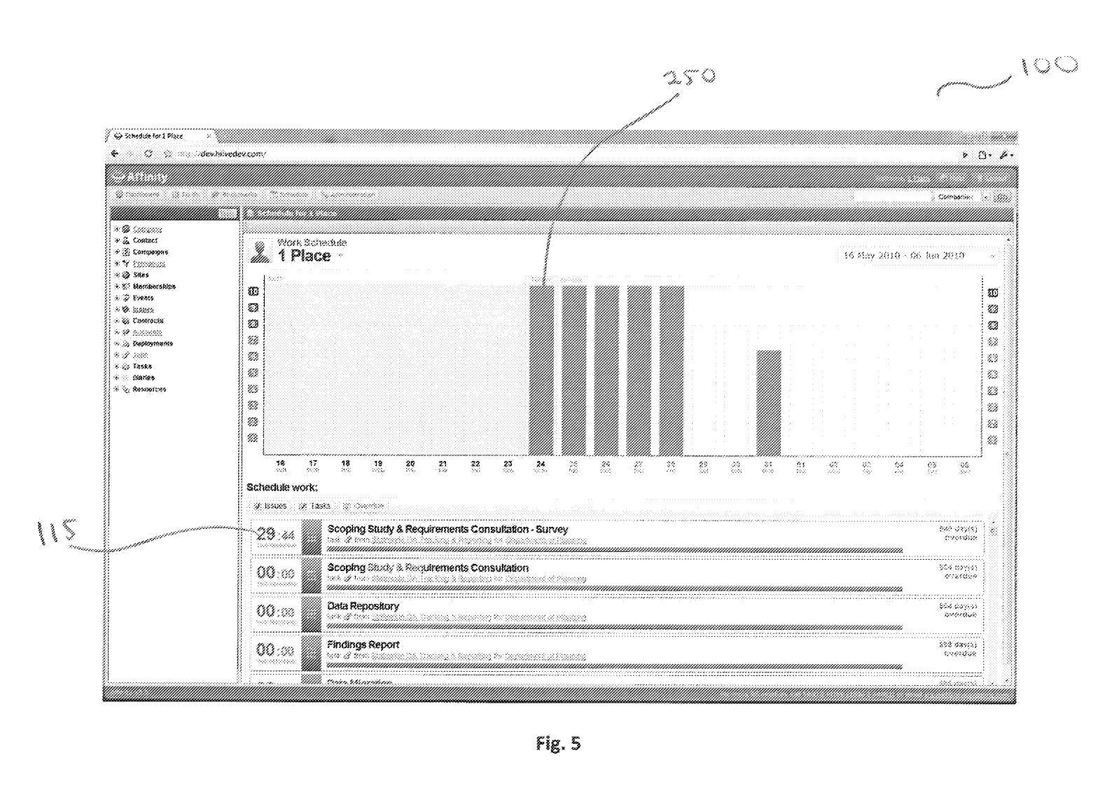

FIG. 5 shows another arrangement of the preferred embodiment with the Task Object 115 and Task Object Communication (TOC) 120 allowing communication between users, including managers and staff:

i. an interface to view time commitments as forecast into the future; and

ii. a centralised means to view tasks that a given user has been allocated to perform.

In a preferred embodiment, task data can be supplemented with additional external information such as expected task allocation times and/or resources available for specific tasks along with the project industry benchmarks as to time and/or resources available and trends. This supplementation of task data enables the building of Task Objects when required.

Task Templates

Task lists often reoccur and therefore a series of template are available to be drawn in as objects for new tasks. These task templates can be searched for or opened as a list as required. A series of task template can also be generated from the previous tasks used and listed on the incidence of use. Selecting the task is performed from a first window of a user interface. Alternatively, task templates can be imported or built de-novo.

Updating Tasks

The preferred embodiment is enabled to integrate additional data in the form of task priority and dependency so as to display the priorities of the task. This display of task priority may also be derived from historical allocations with workflow information incorporated.

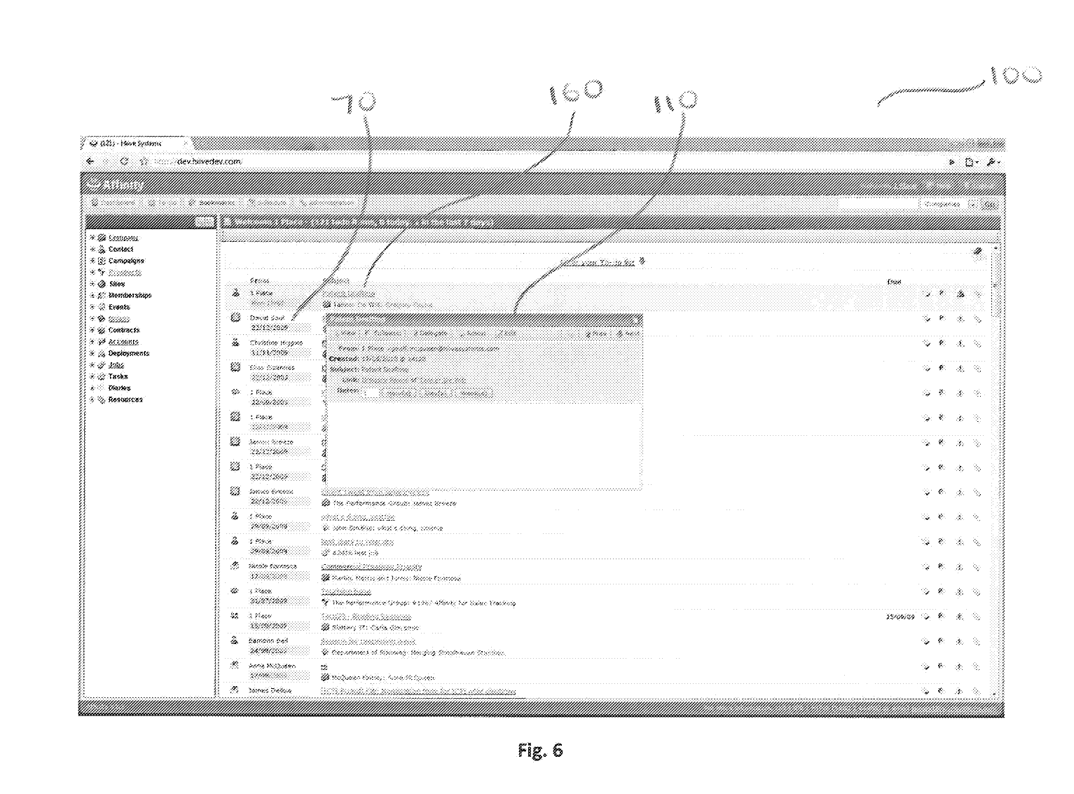

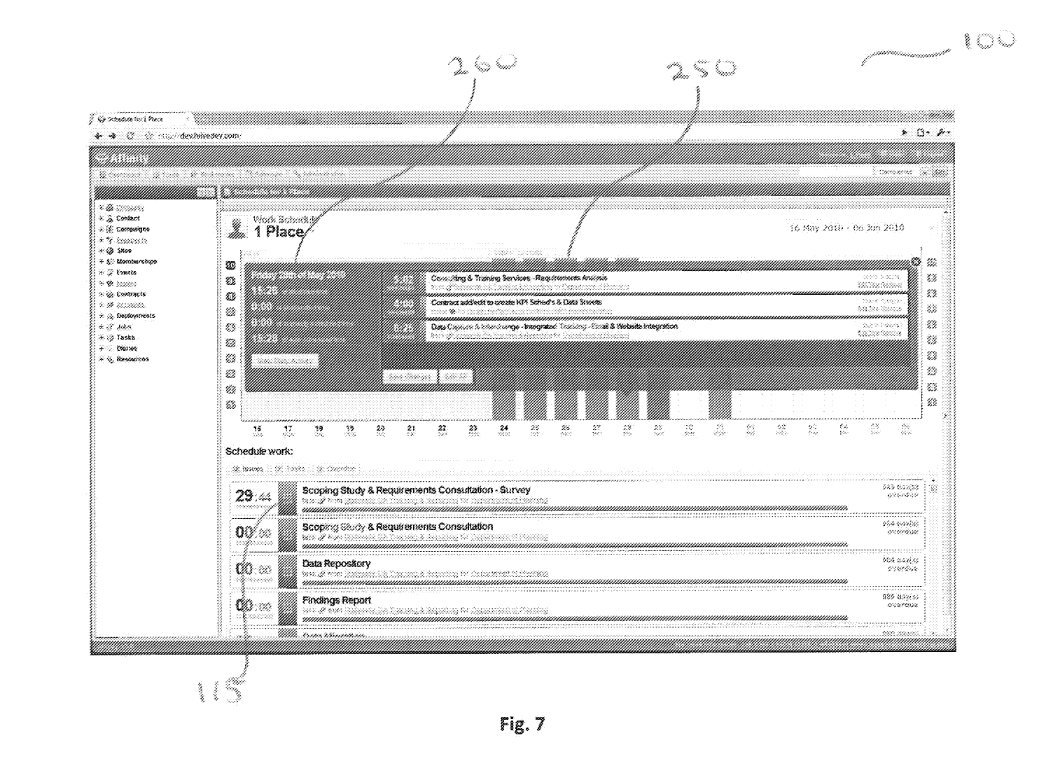

Referring to FIG. 6, the Task Information Collection 110 collects task(s) and their allocation 70 as made available through the user interface. As shown in FIG. 7, the tasks objects and their allocation data 70 is displayed as a task schedule histogram 250—which displays of a collection of tasks—and provides the means of task re-allocation via task data drag and drop over an allocation schedule's histogram.

The task is accessible to the user as an object once it has been committed to tangible reviewable and interpretable form (as opposed to a rubbery and difficult to allocate as mentioned above) once placed into the task collection system.

Further detail pertaining to the task data is enabled to be inserted at any of the stages of task collection, allocation, scheduling, communication and/or optimisation stages so as to enable detail to be provided and reviewed from the user interface.

Task Allocation

The allocation of tasks to a user enables the comparative features of the tasks to be allocated, which are not always captured by the Task Information Collection (TIC). For example a project manager may allocate tasks to workers on a merit basis as to their ability to perform those tasks. Once allocated, the worker can optionally place different emphasis on the specific task(s) and their requirement(s) depending on factors not captured within the TIC data available. This provides the means to directly adjust task allocation through a drag and drop or shuffling of task(s) at either the pre- or post-task scheduling. This is not limited to subjective or objective task schedules. This task allocation step allows the modeling and adjustment of tasks by user(s) at different levels (management/worker/ . . . ).

Task allocation requires regular monitoring to ensure that it meets the specific task requirement(s). The access to the latest allocation time and/or resources available with viewing task allocation on an “as needed” basis via a “Software as a Service” (SaaS) network such that it saves resources and provides the means to obtain up-to-date information.

The user is able to build their own index of tasks allocated so they can optimise a predicted date for scheduling so as to reach a particular service(s) level. This allows the maximisation of output through the use of task allocation analysis in line with time and resources available as determined.

This task allocation also allows the optimal separation of tasks to be combined with external factors such as resources available so that tasks can be broken into particular allocations. This allows real-time decision-making based on current allocation time and/or resources available for particular task specific requirement(s).

The monitoring of allocation time and/or resources available enables user to change strategy to maximise time and/or resources available of particular types of task allocation from the historical access and from the latest allocation time and/or resources available.

Task Associations

Providing the means for task allocation report(s) enables the user to visualise the task allocation(s) as SaaS or the like. This task allocation allows the user to monitor differences in the task allocation over time and with particular associations with other tasks and/or users. Thereby, ascertaining what associations enhanced task performance can be ascertained.

Likewise, different projects can be compared under the same conditions such as time such that a determination of project completion can be ascertained.

Tasks require a better alignment to increase the output of projects. Therefore, the means to educate and provide feedback to users regarding task allocation report(s) is enabled. Providing feedback via task allocation report(s) as to what types of task allocation(s) are successful and what times and/or resources were needed is a means to directly assess output.

The feedback as to time and/or resources is available to inform the user as to whether to delay the task allocation on-project or to send it to near time scheduling.

Task Exchange

Task exchange in the preferred embodiment is part of the task allocation functionality: a user, upon initially logging in via the user interface by inputting a valid user name and password, can access information for which they are granted access to view and, when viewing information such as task allocation or schedule they can exchange it with other members of their team if they are given viewing, allocation, rescheduling and exchange rights.

Potential users can be selected as users of a certain optimisation criteria based on their ability to schedule tasks and the tasks that they are commonly involved in. For example, users that perform better as determined by a quality completion within a time period, with procedural tasks as opposed to substantive tasks, will have the options to exchange their tasks dependent on their strengths.

FIG. 6 shows that when logging into a specific project, a user can view one or more task allocations 160. If the scheduling is underway then a task exchange or task offer can be made by selecting one or more specific allocation(s) by selecting the appropriate Task Object 115, followed by placing the task into a preferred time allocation, such as placing it into an appropriate position in the Task Schedule as shown in FIG. 5.

Through the filter interface, a user can (re)select a specific user(s) as part of a team, specific tasks or specific involvement periods. Users with “process” permission on the schedule preferred embodiment, or who are owners of the object that the Time Estimate is linked to, will be able to change the staff member responsible for the Time Schedule for a specific day, or optionally the whole Time Estimate.

Once a scheduling histogram opens, then a task allocation, exchange or offering will be available. The addition and rearrangement of tasks allows the scheduling of the task allocation to be analysed and accessed/available the viewing within the user interface. In addition there is metadata associated with each task to locate it with the specificities of a super task/project's content.

This specialised allocation of a super task/project's analysis is in addition to known online scheduling information such as a task allocation's description, date and time of the scheduling, resource requirement(s) et cetera.

The preferred embodiment's browser based interface shows scheduling allocations 160 for a user in a particular scheduled project, as available for task exchange, with other users involved in the same project.

Task Schedule

The task schedule's role is to prioritise is to order tasks according to a variety of criteria including its resource usage, age, workflow, dependency, time required and specific task requirement(s) and availability.

In the preferred embodiment, the task scheduled 130 includes task allocation captured in an open format. This enables the task allocation 130 to be available for subsequent review or alternative view in other schedule producing software to produce planning documents, invoices and other formats.

Automated Task Management

Automated task management 70 is performed objectively so the relevant allocation of tasks can be applied via the extraction of like task data (or like time periods) compared with historical data, scheduling algorithms and/or behavioural files. That is, if a task with an estimate of 40 minutes duration is assigned then the allocation of time may bring forward a dialogue box stating that previous estimates of this time period have not been completed in the scheduled time. The dialogue box may also suggest an adjustment of the time period to be in line with previous task completion. Alternatively, a re-allocation of the time (in a scheduling context) may take place due to the task management software noting that tasks are never completed on a Friday afternoon after 7 pm.

Deterioration in task management may take place such as slippage of the task completion, so task updating is one means available to enable the user to perform an intervention to overcome any detriment to the task allocations.

Other methods for overcoming task deterioration include the implementation of task allocation strategies via the use of the policies derived from previous successful project management strategies. Therefore the selection of policies to the scheduling of tasks can be made preceding the task management, so as to highlight risks relating to task slippage and other forms of deterioration that may occur in task schedules.

Tasks with Missing Information

The task allocation and scheduling also manages the unmeasured qualities of the task allocation including:

a) the time available of unmeasured task allocation (that is, the task has not got a time period allocated to it yet but may have other data such as its priority); and

b) how the task allocations holds together in that there are policies that may be allocated to indicate that task XYZ together will have a better performance and out output than task ZZZ which tends to have decrease in performance.

Missing task information can be allocated:

a) Subjectively, by using a task template as built from previous tasks; and

b) Objectively, by using task information from behavioural files and task algorithms that draw information from completed tasks.

These examples are important in establishing the task's available time and/or resources based on:

1. unmeasured task allocation(s), and/or

2. how the task allocations hold together.

Allocation of missing information aids the scheduling by both the user (subjective) and the automation tools (objective) to determine the speed at which the task allocations can be performed by a user, since this affects the turnover or through put of the tasks.

The scheduling of tasks using historical or preceding task allocation(s) completion also provides information for task with missing time and/or resources requirements. This information can alternatively be used to enable task allocation exchange by searching historical information, behavioural files, algorithms et cetera and see how well one user's data reflects the other user, so the fit of the exchange can be evaluated.

Historical Data

The historical time estimates are enabled to be viewed and assessed to state whether estimates and completion of tasks are aligned. When there is a constant error in specific time intervals or with specific tasks then a software generated estimated work schedule is enabled to be generated and overlaid on the user's estimated schedule such that the a difference between the two schedules can be revealed.

This provides a feed-forward path to the user to reveal the inaccuracies that are likely to exist with their current estimates. As the user takes into account the estimated work schedule based on historical completion times compared to their estimates then the user is enabled to tweak their estimates more in line with their historical performance. This provides feedback to the software generated estimated work schedule so more recent performance has greater weighting than aged performance data.

Managers and staff are enabled to use the software generated estimated work schedule so that they have the ability to change the start and due dates for Time Estimates, and to have Time Schedules which are of type to automatically change accordingly. This is also incorporated to spread out workload, particularly if a staff member is facing an unmanageable workload in a specific period of time.

Historical Record Access

Past tasks performed by a user and/or project basis are listed and available in the form of a popup and/or dialogue box, which on selecting brings forth the details of the historical task management. Here a user can select a historical task that may have been completed and has similar features to the current task that need to be performed.

Historical Record Amendment

If the historical task has data that has not been recorded correctly, then the user may amend this record. This allows the adjustment of historical records to be aligned with practice. This enables objective schedules are to be adjusted and re-run if historical data is incorrect. Therefore, amendment of completed tasks must be available to allow correction of the historical and/or behaviour files.

The user interface contain access to information sources and outputs which set the conditions of the task management such as access polices, algorithms, adjustment schedules, historical records etc. This enables the objective scheduling of tasks to be adjusted when scheduling time and/or resources available. The adjustment may involve using a selection or all of the scheduling tools including access policies, algorithms, adjustment schedules, historical records et cetera.

Optimisation

The task schedule when optimised distinguishes each task allocated based on characteristics captured or not captured. The optimisation reveals how task allocation responds when being scheduled in a particular manner. This enables the user to appreciate the difference in subjective input with the planning fallacy component compared to objective scheduling.

The automation of task optimisation presents a suggested objective schedule which is not enforced over the user's subjective schedule, but it is a suggested alternative.

Consequently, the preferred embodiment provides a means to test the optimisation of the schedule by one or more users. Therefore, modeling of the task allocation can take place by users who have their own subjective criteria. Thus, the task data analysis of task allocation can also reconcile task allocation optimisation standards over time.

The present embodiment overcomes the above-mentioned prior art attempts in providing useful task management that overcomes the problems with the prior art scheduling of specific tasks as subjectively allocated by the user.

Task Schedule Optimisation

Task management involves tasks and/or sub-tasks to be optimally allocated to the time available. A task's allocation over time provides an indication of the time absorbed and capacity of the resources. In the preferred embodiment the user is able to:

1. forward manage the time and resources in a human readable form; and

2. reschedule tasks dynamically.

Workflow Over Grouping of Tasks

Scheduling of tasks traditionally has involved keeping like tasks grouped together to be performed by a specific resource. However, this is not how a project is performed. To move away from this traditional, the preferred embodiment has the option to incorporate workflow in allocated preceding/pending tasks as opposed to grouping like tasks together.

Optimisation by Viewing Polarities

The preferred embodiment incorporates task information with optimisation techniques to interpret the task parameters from data that draws on the difference between:
a) Belief—subjective scheduling as task are selected and allocated by the user based on their belief as to the task's requirements in order of time or resources (referred to as a “planning fallacy' in the Background); compared to
b) Behaviour—objective scheduling obtained from the user's historical behaviour with regards to task handling and completion data.

The automated optimisation of tasks enables the ability to reconcile:
1. specific resource requirement(s) and their availability, with
2. the allocation of time that such resource are required;
   however, in practice such automation draws from the user's historical data, policy(s), exceptions, workflow, dependences, et cetera more than from a scheduling algorithm alone.

Optimisation to Model Outcomes

Optimisation enables the user to assess the automated schedule and to tweak it or, alternatively tweak the user generated schedule to align it to reflect both belief and behaviour. This tweaking is performed by adding, removing or re-arranging tasks (or their underlying information) to further optimise or model the schedule to meet particular needs and outcomes.

This tweaking further allows up-to-the-moment appraisal of schedules and the ability insert unknowns as they arise—be they in the form of time and/or resources availability—so as to keep the schedule aligned with issues as they occur.

Reconciling Belief and Behaviour

Optimisation through subjective (user allocation) and objective (automated allocation) along with the difference between the two is a means to truly reconcile task management, since neither objective nor subjective allocations are rarely reliable when used alone.

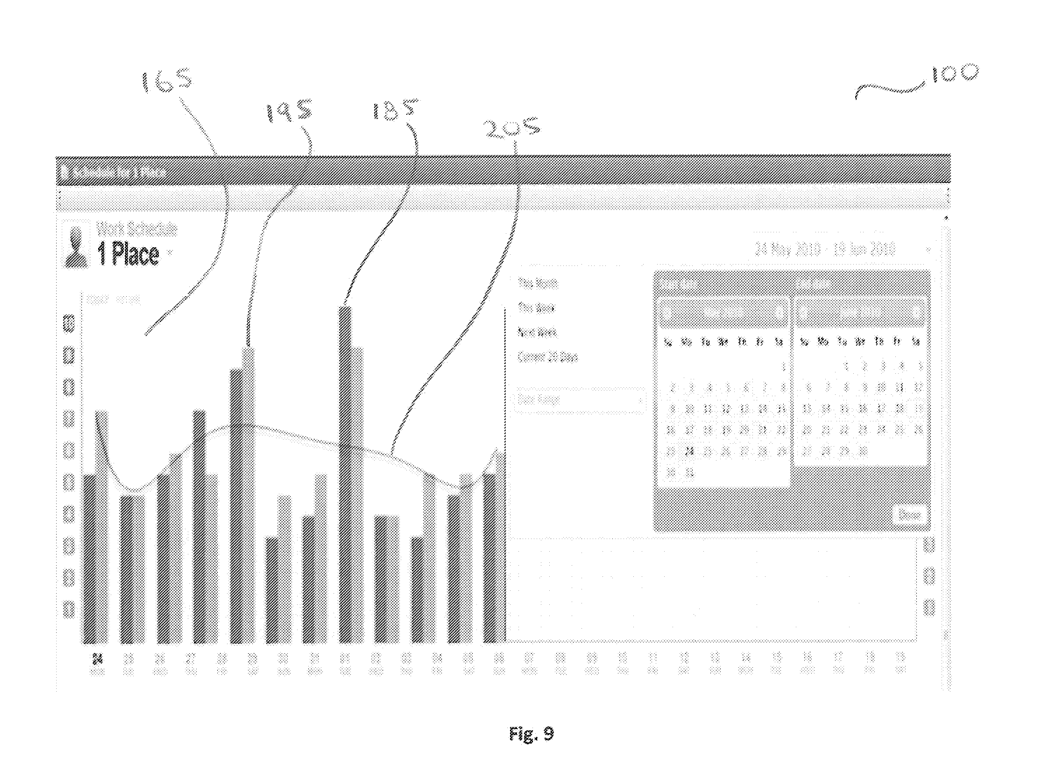

FIG. 9 shows the reconciliation between objective schedule 195 and subjective schedule 185 as discussed earlier in FIG. 4, with Task Management Optimisation 165 shown with the addition of a Trend Line 205, which is showing the trend in the mean result between the objective 195 and subjective 185 schedules and how the resources are allocated to fit. This is used as another tool to show with all tasks allocated, there may be other pieces of information available to users such as trend data to show whether the future week has been over allocated with tasks.

Task data that is initially scheduled for a specific time as set by the user may also have an error/adjustment value added to it so as to make the subjective allocation of time be more aligned with the objective time taken for the task completion. This adjustment value is referred to as a time estimate fallacy value (which is discussed in the Background above).

For example, a time estimate fallacy value is used as follows: if a task A is scheduled to 2 hours then the allocated within the task manager is set at 2 hours+20% time estimate fallacy value taking the total allocated time as 2 hours 24 minutes. The time fallacy estimate value can be set by the user as the user is the best estimator as to what they are like at estimating particular slippages in their schedule.

Behaviour

The subjective task allocation with its inherent planning fallacy is enabled to be evaluated, and reconciled with, the behavioral patterns of the user such as the number of times a task is rescheduled and the length of time that the task is rescheduled for. This is collected from a variety of sources including the user's activity logs which records task bumping/ completion and other data.

These activity logs are monitored by algorithm(s) reading the log files of particular task in particular time and resource epochs (the epoch for minutes, hours and days may have very different behavioural responses and therefore the algorithm detection of slippage in one epoch of task time allocation such as days may keep that slippage together and keep another adjust for tasks scheduled in hours).

The detection of time slippage and the re-alignment and/or rescheduling by the task manger can then adjust the time estimate fallacy value to bring it into line with the behaviour of the user. The detection of a behavioral pattern as different from a task completion activity data may be compared to a previously defined or generated profiles such as the time estimate fallacy value.

Other tools used to objectively compile a user's behaviour include policy(s) containing rules of activity, workflow, dependency(s) et cetera.

Behaviour Files

The behaviour of the user and or a team (or collection of disparate users) may be initially determined from historical records such as log files or the like; however, as the records grow the implementation of behavioural files for individual users or collection of users is implemented. This is to overcome the problems of access and resources used in processing historical large files. It also provides a means to dynamically tweak the scheduling to be aligned with a user's or population's behavioural characteristics particularly when the historical data is incomplete or missing critical information.

An example of a behavioural file drawing from the detection of a behavioural pattern may indicate the accuracy or otherwise that a user subjectively allocations information to a particular task or schedule. For example, a user may have poor task information appreciation if there is adjustment of tasks as follows:

1. the frequency at which a user reschedules a task;

2. the size of the task is adjusted in a particular direction; and/or

3. the time re-allocated to perform the task.

An algorithm may be selected to be invoked when a user has attempted to access information more than preset number (x) of times for tasks that fall in the range of a predetermined time period (y). These x and y values entered by the user after preset mean periods have been implemented from observation data. For example, if a user reschedules a task more than four times over six days, then this task is flagged as correcting the time estimate fallacy value to be within the range of time that the task is taking to be performed.

Behaviour Policy

Some tasks with automated time adjustment via the time estimate fallacy value include implementing a policy that will give rise to specific alerts if the time adjustment falls outside particular values as set by the policy.

This policy violation alert is an important means to alert as to the impact of a time adjustment. When a time adjustment impacts on other individuals using the same task scheduler the alert can notify all involved that there is a shift in pre-scheduled parameters. Alerts or notifications may be by way of e-mails, reports, pop-up messages, or system messages.

The rescheduling of a task usually effects subsequent task allocations—often having a domino effect causing exponential impact on the project as a whole. Having policies to flag the impact of task rescheduling so as to model outcomes is a means to direct the user to make a better decision.

This method of managing tasks to reflect the user's activity as objectively performed is a means providing a task management rules that reflect the user's behaviour and not the user's subjective expectations.

The task manager also stores historical data, such that rolling averages in particular epochs and for particular tasks can be used to adjust the time estimate fallacy value, since management of the task may be better estimated over time and performance for performing the task may also change. Consequently, the user can tweak the time estimate fallacy value as they learn more about their time management.

The preferred embodiment also includes the automated analysis of the task and sub-task rescheduling and completion data in the activity log file, database or other means to detect a condition and, when the condition is detected, generating an adjustment of that condition. Therefore, the task management with “smart” allocation of one or more tasks in the form of quantitative information is enabled along with the scheduling available to be reported on demand as task management optimisation.

Behavioural File Normalization

A user's, or a plurality of user's, behavioural files may be normalised by using a plurality of user's time slippage characteristics, and applying this slippage as objectively to those users that do not have a historical record of their performance.

This enables fair time estimates to be available at when automated scheduling takes place; therefore, the task information is current when viewed and it is available to be automatically rescheduled if/when slippage occurs.

This presents the task allocations from many users to be available which is advantageous for project work involving many users, as opposed to task allocation analysis based on the performance of the single user, which can provide a very different result to task allocation that is available collectively.

Tasks with Missing Information

The task allocation and scheduling also manages the unmeasured qualities of the task allocation including:

c) the time available of unmeasured task allocation (that is, the task has not got a time period allocated to it yet but may have other data such as its priority); and

d) how the task allocations holds together in that there are policies that may be allocated to indicate that task XYZ together will have a better performance and out output than task ZZZ which tends to have decrease in performance.

These examples are important in establishing the task's available time and/or resources based on:

3. unmeasured task allocation(s), and/or

4. how the task allocations hold together.

Allocation of missing information aids the scheduling by both the user (subjective) and the automation tools (objective) to determine the speed at which the task allocations can be performed by a user, since this affects the turnover or through put of the tasks.

The scheduling of tasks using historical or preceding task allocation(s) completion also provides information for task with missing time and/or resources requirements. This information can alternatively be used to enable task allocation exchange by searching historical information, behavioural files, algorithms et cetera and see how well one user's data reflects the other user, so the fit of the exchange can be evaluated.

SaaS Access to the Schedule

In one arrangement this task allocation information is delivered as “Software as a Service” (SaaS) from a central online task collection/allocation/scheduling server.

In the preferred embodiment as shown in FIG. 2, the preferred embodiment has information accessible for viewing on demand. The data is submitted to the TIC 100 which, in one arrangement, is a computer enabled device such as a server containing a database 110 which, via a network, is attached to the information communication means 75 which is enabled to communicate via the Internet to a user's computer 140 once suitable authorisation criteria have been met.

Access

The authorisation request is authorised by a login and password such that the authorisation logic can validate the request and enable access to view the requested data. The preferred embodiment also enables the auditing of access and downloading only authentic task authorised to be accessible to the verified user so as to ensure that the task allocation has not been tampered with. This is achieved by writing the information request into an access file 105 which access the user's request and open up the access once validated.

Browser View

Referring to FIG. 5, once a registered user has logged in, then this user will be taken to a user interface, which in the preferred embodiment is a browser based solution. This user interface is where the user is able to access scheduling data from:
a) tasks allocated 115; and/or
b) projects for selection, which, in the preferred embodiment, is a list of projects with their underlying tasks.

The user interface has a series of windowing means where building of task objects from task information takes place. This leads to a second windowing means where the output of task analysis takes place to show the difference in the subjective and automated objective task objects as well as a third windowing means for displaying one or more subjective and/or objective Task Schedules.

Future tasks as scheduled are available in a histogram 250 format as a collection of all tasks or by tasks relating to a specific project.

Selective Access

The ability to regulate what a potential user, or viewer is enabled to view is determined via the access rights granted through the login and password. This feature is the means to control the allocation and scheduling by selecting the participants so as to make the scheduling private, public or in some form in between. This is the means to govern who access what tasks, projects and other information.

For example, a user may be given a series of tasks to perform; however, they may be kept from viewing any of the projects that these tasks relate to since project objectives may have commercial sensitivity.

User Interface

Histogram Display

The preferred embodiment's scheduling displays the qualities of the scheduling through the histogram display and analysis of over or under scheduling of tasks on a day by day basis.

FIG. 4 shows a Task Schedule as histogram display 250 which enable the user to perform an examination of the histogram bars and the task object(s) contained so as to reconcile the task allocation with the display the stacked tasks whose height relates time allocation that day. If the histogram is too high it will cross into a region of where time can no longer be allocated to perform that task.

This display of task allocation avoids the over allocation of tasks and sub-tasks on a particular day, which otherwise takes place when a user manually lists tasks into a calendar like task manager. By committing the task allocation information as objects in a task schedule's histogram display 250, each task/subtask is available for review, and if necessary, re-allocation, and/or subsequent review and modeling through using the task data drag and drop functionality.

The forward scheduling starting from today provides high level, graphical view of tasks scheduled across a defined time period for a user such as a staff member or a team. Thus, information accessibility is enhanced when the data is placed into a histogram display in which the user can drill down or reshuffle tasks as required through drag and drop task management.

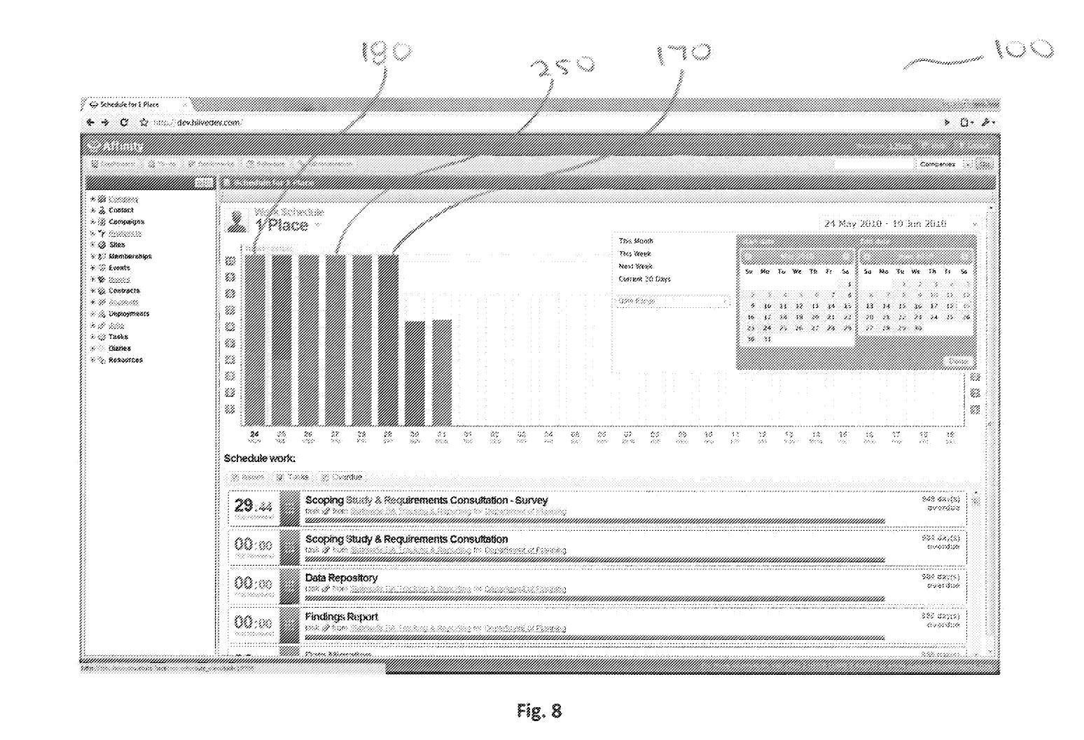

The preferred embodiment's provision of “drill down” functionality to reveal the contents of the task allocation histogram without leaving the histogram is shown in FIG. 8. This allows users to change estimates (user/staff member the time estimate is for, the start date, due date, or hours remaining) and schedules (move time from one day to another, or from one user/staff member to another), and have this information represented in the charts and lists, using technologies such as an AJAX style in-page update, or through a full page reload.

Referring to FIG. 8, the task schedule histogram 250 enables a viewer to determine the schedule of the listed tasks 260 as allocated by the user and/or the task optimisation software.

FIG. 7 shows task allocation into a scheduled as displayed in a histogram 250 with each histogram epoch 170 being a day (or any other time interval) determined on a start day being today 180 forward (or any other start day) for five days forward (or any other number of days forward) enables a user or team to perform task allocation(s) to sort the tasks according to a variety of criteria including the time available, resource availability, experience in the area/experience required to be gained in the area. Once a task is completed then the task is removed from the task management forward scheduling. The task completed information data is kept in log files or other files for which data can be extracted from.

Real Time

The advantage of the task management being accessed in real time by a user allows task schedule and/or optimisation to be assessed and corrected by the user. This can also be communicated to other project participants so as to show the subtleties of the decisions in making the assessment and any rescheduling that may override the task schedule and/or optimisation software's assessment.

Use Cases

There are numerous use-cases for this preferred embodiment, broken down below by the types of users who would most commonly be a party to the use-case. Examples of the different types of users follow below.

Managers

Managers, for example, use the preferred embodiment through the schedule view to get feedback on the time utilisation of their staff members, as well as view visually the time utilisation of staff members historically. The visualisation of a single staff member's schedule or a group of staff member's schedules, on one page enables a means to quickly visualise and ascertain the progress of the project and its underlying tasks.

Managers are enabled via the software's scheduled work to allocate and reallocate estimated time into the work scheduled on specific days through a drag and drop mechanism, so as to better solidify work activities and to reflect the way people really work (usually as blocks of time on a task, rather than as small chunks of time on a given activity over many days). This functionality enables the user to handle the splitting of a Time Estimate into multiple Time Estimates using a parent/child arrangement—so that pieces of time can be allocated to different users/staff members.

Managers use this preferred embodiment (through the activity view) to see what staff members have scheduled and estimated as activities to work on a given day or week—this interface will be the same as the sole worker uses to observe at their own scheduled activities.

Workers

Workers, such as staff members, contractors, and other sole or small collectives use this preferred embodiment (through the schedule view) to visualise what their schedules look like into the future, and more frequently, to turn rough time estimates into scheduled time. This makes it easier for users to plan their time, but recognising that the schedules of service professionals are inherently rubbery and difficult to allocate with fine grained accuracy.

Workers are also able to use this preferred embodiment (through the activity view) to plan and report on their daily or weekly activities. They will be able to see list a list of all activities that they should and could be working on through the course of a day, and they will be able to enter logs of work done (like timesheets) against the time schedules on a given day or week. Entering these diary entries will allow them to re-estimate the time remaining for an activity.

Managing the Future Workload for a User/Staff Member

Managers need to view the future workload of a staff member—for example, when:

1. assessing a leave request;

2. modeling whether the company can take on new work that this staff member would need to be tasked with, or

3. dealing with a user/staff member being sick or injured (and needing to get an understanding of whether this work can be re-allocated or whether deadlines need to change and clients need to be informed).

Managers achieve this by using the “Schedule View” screen, and selecting a specific user/staff member from the filter list of all staff members.

A manager is enabled to change the time estimate or schedule of a given user/staff member (because they are sick/away/unavailable/overloaded) by selecting that user/staff member's day which reveals a scheduled tasks and their time and resource requirements. By selecting an activity on the user interface the manager is enabled to change the user/staff member that the activity is allocated to (likely through a user/staff member drop down list rather than drag and drop). Further, the start and due dates of the activity can be altered to adjust the estimate for that day (by reducing it or moving it), and in the situation where the work is scheduled, the manager can delete that scheduled work entirely.

Managing the Future Workload for a Skill(s) Set

Managers will need to be able to see the workload for multiple user/staff members who fit a specific skill set.

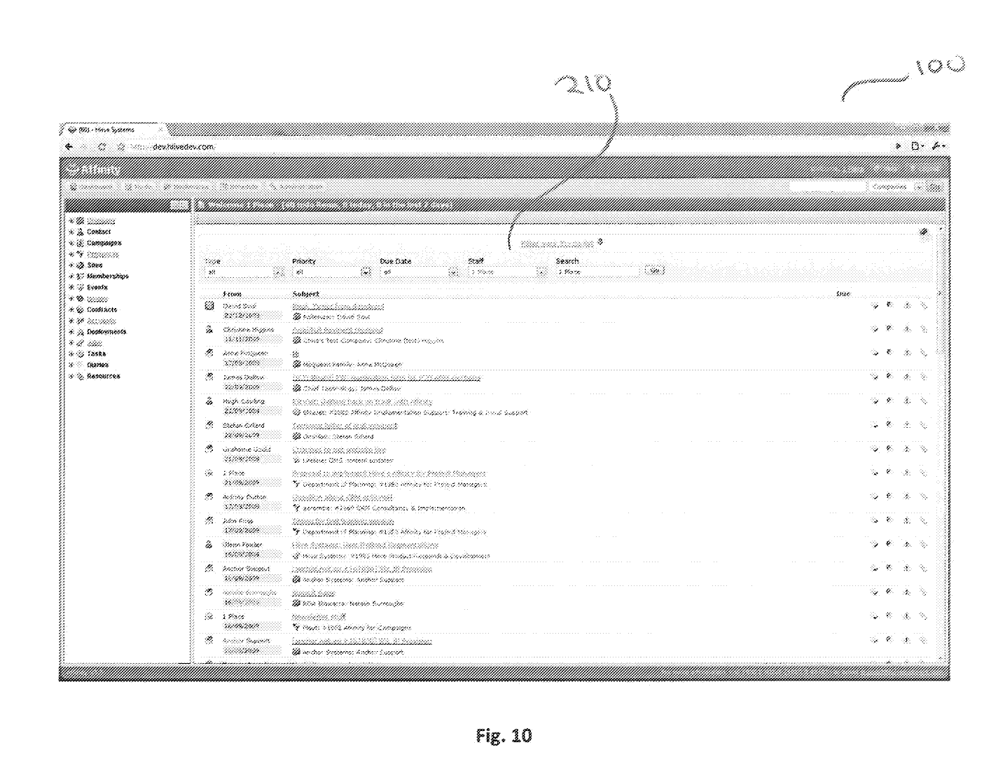

Through the Schedule View screen as shown in FIG. 10, users select through a filter interface 210 the skills they are looking to see, and if more than one user/staff member matches the skills selected, then the multi-staff schedule view will be used.

When viewing via this interface, it makes sense for the “unallocated” Time Estimates relevant to the time frame to be displayed, potentially filtered by the Time Estimates which fit the specific skills. It will be important to allow multiple skills to be selected through the filter interface, and to display the unallocated Time Estimates which match any of the skills required. It is also going to be necessary to display on the unallocated Time Estimates which skills they require so the manager can more easily see what skills the Time Estimates require, and what users/staff members have schedule capacity to handle this work and have it allocated.

It is envisaged the Time Estimate skills will be managed completely by the activity they are linked to, e.g., Task, Issue, etc., however in creating a split-off/child Time Estimate, a user will be able to select only a subset of the skills are appropriate for that specific Time Estimate.

Managing the Future Workload for a Team

Managers will need to be able to see the workload for multiple users/staff members, either because they are reports to the current user (manager), or because they are selected by the current user (manager).

Functionally, the manager will want to be able to click on a specific user to see a list of the scheduled and estimated activities a user has down for the time period represented by the chart, with the ability (if they have process rights) to then edit the Time Estimate as a whole.

Managing Future Workload for a Job (or Other Activity)

Managers will need to be able to see the workload for an entire job (or other Activity), including the Time Estimates against the job/activity itself, as well as the tasks and issues (or other activities) that are against that job/activity. They will need to see all users/staff that have Time Estimates against a job (will include both the Time Estimate's that come from structured task owners, as well as specific bits of work that might have been created as Time Estimates for non-task owners).

This screen enables managers to see bottlenecks on a specific job. Note, as described on the Schedule View screen, the bar-charts will show visually all work that a user is scheduled or estimated to complete on a day/week/month basis, not just that related to this job, however, it is going to be important that we balance the needs to see what else could be keeping the users/staff member from focusing on the specific job we're looking at, while at the same time recognising that this screen is intended to highlight the work being done against this particular job.

Viewing Historical Work Done by a User/Staff Member

Managers will from time to time want a visual representation of the work performed by a particular staff member or members. This is a core feature of any schedule view screen, and will apply whenever the date range being examined includes dates before today.

These bars on the chart should show the time that a user/staff member actually logged through diary entries, with a representation of the total number of hours they were available to work that day. This will show when their logged time was below that expected of them for that day/week/month, according to the availability calculations.

Viewing Scheduled Work Not Done by a User/Staff Member

Managers can also view the Scheduled work that was not completed by a user on a given day. The test for work being not completed will be work which is scheduled—not estimated—which does not have a diary entry pointing back to it.

View Work Planned for a Specific Date Range for a Specific User/Staff Member

If a user/staff member is going to be on leave or otherwise unavailable (perhaps the project manager wants to devote 100% of their time on a specific, different job), a manager can view the specific work scheduled as well as estimated for a specific user/staff member over a specific date range.

From this screen, the manager (if they have process permissions on the scheduling preferred embodiment) will be able to edit the start and due date for Time Estimates, which will result in the modification of the Task Schedule objects (see Editing Time Estimates) and the redrawing of the work planned screen.

View Work Complete for a Specific Date for a Specific User/Staff Member

Schedule View

The schedule view screen will actually display in three modes—a single user/staff member mode, a multi-staff member mode, and an unallocated mode (which will show a selection of staff members based on the selected filters, and then a list on unallocated Time Estimates, which can then be allocated to a user/staff member through either a drag and drop or a pick-list type of arrangement).

This screen will be defined by the date range, which the user will be able to select from the date chooser at the top of the screen. The date chooser interface allows a user to choose a start date and an end date to display on the chart.

Users also select whether to show individual scheduled (bar charts) as days, weeks or months.

If the user selects a date range which covers more than 28 days, the interface will automatically snap to show the schedules based on weeks (so as not to slow down page load time with an excess amount of data). Similarly, if the user selects a period of more than 336 days in size, it will automatically snap to monthly view.

This screen will default to Single User/Staff Member mode, and will show the daily schedule of the currently logged in user/staff member for the previous 7 days and the next 14 days (21 days in total).

Adding Diaries

Adding diary entries will need to be modified to handle the Time Schedule and Time Estimate concepts.

Where a diary is being added or reported on which is linked to an object which has a Time Estimate, and where the current user is the owner of that Time Estimate, the user will be presented with an additional field where they can re-estimate the time remaining for that Time Estimate.

Additionally, if the user is recording a diary entry for which there is a schedule Time Schedule object (as opposed to one of type=estimate), and where that Task Schedule object is scheduled for the user entering the diary entry, then the diary entry should be linked to the Time Schedule object through a many-to-many link table.

Editing Time Estimates

Editing a Time Estimate will need to be supported through a number of screens. Implementing the functionality of editing a Time Estimate will need to be done at an object level, as changing Time Estimates can result in updates/changes to linked activities, as well as the recalculation of the Time Schedule objects that come off a Time Estimate.

If the Time Estimate is an ‘auto’ Time Estimate, then it should update the linked object, so, for example, a task is what the Time Estimate links to, then extending the due date should extend the due date on the Time Estimate. The same goes for the start date, but the estimated budget in hours and the ‘duration’ shouldn't be adjusted (so performance against the workflow plan is not corrupted).

Whether the Time Estimate is auto or not, editing the Time Estimate should then result in the re-drawing or re-estimating of non-scheduled Task Schedule objects. Specifically, type=estimate Task Schedule objects need to be re-calculated over the time periods between the Time Estimate start and end dates, and for the estimated time that hasn't yet been allocated into a scheduled Task Schedule, updated Task Schedule objects need to be built to reflect the changes in the Time Estimate.

Changes in the Task Schedule objects will require the re-drawing of screens that depend on the Task Schedule objects—such as the graphs on Schedule View screen and all items on the Work View screen—which is to be expected, and will need to be taken into account when building these screens.

Example of Use

A manager needs to visually determine what the future workload of a staff member(s) looks like, so they can manage workload, client commitments and overall business profitability effectively. Likewise, a worker wants to be able to see visually their future workload looks like, so they can manage their workload and see in advance whether there are going to be problems meeting deadlines others have set.

The following user stories address specific pieces of functionality from this screen.

Viewing Work on a Date

Editing Scheduled Work on a Date

Editing Estimated Work on a Date

Creating an Exclusion on a Date

Editing an Activity Estimate: Hours Remaining

Editing an Activity Estimate: Start and Due Dates

Turning Estimated Work into Scheduled Work on a Date

Requirements

This screen defaults to show the current logged in user's schedule.

This screen contains a bar chart, covering a date range:

The default date range is set to have a retrospective view set back one week, and forward three weeks.

The date range is set by a date range picker. The picker allows the user to choose a “start date” and an “end date”, and then the schedule is redrawn to show the each day/week/month between that date range, including the start and end dates.

The bars on the bar chart are colour-coded to help the user distinguish between types of time, specifically separating out:

Unavailable time—this is grey or other “you can't play” colour, which will be used to show a whole day isn't available. Partial daily unavailability will be handled by shorter “total available” bars.

Historically recorded time—this shows the time that was actually logged as diary entries, and is a solid block of colour on time in the past. This will of course include previous days, along with time logged during the current day. Something like blue would make sense here.

Scheduled time—this shows time into the future which has been “scheduled”. ‘Scheduled’ time will be created in one of two ways:

The user can specifically create a diary with a start and an end date/time. This will create an automatic Time Schedule linked to that diary entry for easy display in the chart, or

The user will have previously converted Estimated Work into Scheduled Work on a Date. Because this time is blocked in, it appears at the bottom of the bar chart.

Estimated time—this shows time into the future which has been “estimated”. Estimated time is the time that the system thinks it will need to be allocated on a day by day basis to get an Activity completed by its deadline; because it is averaged and a guess, we want to show it on ‘top’ of the scheduled time.

Overdue time—this will apply only to the section of the chart representing today (so, if the selected date range doesn't include today, then it won't be shown at all), and will include a bar on top of both the scheduled and the estimated time of a different colour. This bar will be a sum of all of the remaining estimated hours for an activity which has a due date in the past. Visually, it could be tricky to show this (if there is a lot of overdue stuff, the bar could be quite high) without changing the scale for the whole chart so much that the rest of the bars become indistinguishable. It could be desirable to either toggle this off by default, or place the bar in a different part of the screen (so it doesn't screw with the Y axis scale for the schedule), or alternatively, instead of lumping overdue work onto “today”, displaying the “work” for each overdue Time Estimate on the day that the Time Estimate was due, with a height equal to the number of hours that the Time Estimate still has remaining.

Max availability is shown as a box outline on a day by day basis. The boxes will be determined based on the default for the company (for example, 8 hours per day on Mon, Tue, Wed, Thurs and Fri's), and then based on exclusions on the company level (e.g., no work on the ANZAC Day Public Holiday), and then based on exclusions on a staff member by staff member basis (such as someone being on leave on a certain day, or unavailable for 4 hours).

The time groupings are “merged” together by their colour and their date, and not displayed as individual small bars of time of a certain colour. This is to cut down on the amount of overhead required to transmit and render data (a period of 28 days could involve thousands of individual time slices).

If the user selects a date range which covers more than 28 days, the interface will automatically snap to show the schedules groups by week (so as not to slow down page load time with an excess amount of data). Similarly, if the user selects a period of more than 336 days in size, it will automatically snap to monthly view. The user will be able to “over-ride” these snapped values, and the system will need to remember their snapped preference if they change the date period, but it do not store the preference against the user after they leave this screen.

When the user clicks on a coloured section of bar, an AJAX powered “more information” section below the chart will change to show the work details related to the date and colour they've clicked on. If the user clicks on the “date” X-axis title, then the “more information” section will show all of the entries for that date, including any scheduled, estimates, overdue and exclusion entries (in that order).

For each time entry in the “more information” areas, the user views:

For scheduled and estimated time, the Activity the time entry is against (i.e., Task X in Job Y for company Z, or Diary “meeting”, subject ABC, against Task X in Job Y for company Z)

For scheduled time, the number of hours that are scheduled for that day.

For estimated time, the number of hours of work remaining on the whole Time Estimate, and the due date for that time estimate.

For exclusions, the title of the exclusion, and the number of hours of the exclusion (or “all day”)

Additionally, this section of the screen will need to support the functions described in more detail in sub-stories related to editing schedules, editing overall time estimates, and converting estimates into scheduled time.

The task management display with optimisation and user adjustment has the following advantages:

Traditional Schedules Does Not Provide Adequate Information

Task management is as much of a science as it is an art, and therefore, the optimisation of the task management features in a quantified objective manner can often overlook qualities (such as subjective insight to the task needs) contained in the task schedule that is not part of the standardised analysis. Therefore, task scheduling appreciation needs both the objective scheduling subjective scheduling in the task display. Consequently there is a great need to have a task display enabling the optimisation of output by comparing objective scheduling compared to subjective scheduling to allow the viewing of the benefits of each.

2) The Analysis of Previous Allocations Compared to Future Offerings is Available Via Task Allocation.

This allows appreciation by both: a) user to nominate a fair time; and/or b) resources available to be reconciled with the task optimisation software.

3) Reliance on the Speculative Task Allocations is Reduced.

The detail of a task as allocated by the user and analysed by the task scheduling and optimisation software enables the user to schedule on more direct and objective information.

4) Potential Scheduling by Those Who are Not Initiated the Optimisation System are Able to Obtain an Appreciation Via the Task Management and Optimisation.

This potentially opens up users to this new form of scheduling, who may not be au fait with optimisation techniques used. Consequently, the ability to provide optimisation techniques with actual visual appreciation of the new scheduling allows the user to reconcile and appreciate their subjective task schedules with objective task schedules via the schedules optimisation. If a user has no history of using scheduling techniques, they are able to use a normalised behavioural file to provide insight into expected results.

The invention provides an improved or alternative method, system and tool for displaying task schedules, including the analysis of the task allocation by task optimisation. However, it will be appreciated that the invention is not restricted to these particular fields of use and that it is not limited to particular embodiments or applications described herein.

1. A task management method including the steps of:
a) collecting and storing in the memory of a computer task information including the following:
(i) task requirements including one or more of the following task requirement data:
i. time;
ii. resource,
iii. priority;
iv. policy;
v. rules;
vi. workflow;
vii. dependency;
wherein said task requirements define said task; and
(ii) metadata including one or more of the following:
i. task name(s);
ii. task goal;
wherein said metadata describes said task; and
a) processing said task requirements and associated metadata in said computer for building one or more task objects;
b) analyzing said task requirement data by performing one or more of the following:
(a) subjective estimates such that said task requirement data are entered into said computer as estimates by one or more users as associated with said metadata as subjectively acceptable to said user(s); and
(b) an objective evaluation performed through making, in said computer, an objective comparison(s) with one or more of the following:
a. past task information collection means such that past task requirement data are compared with like unfulfilled task requirement data;
b. a user's behavioural file(s) such that a user's behaviour is enabled to be compared with completed task requirement data;
c. behavioural algorithm output(s) wherein task object fulfillment is extrapolated from a user's behavioural file(s); and/or
d. normalised group data of like task information collection means wherein the application of said normalised group data is compared with like subjective task information collection means; and
such that said task information collection means is objectively evaluated against historic, external and/or extrapolated task information collection means; and
c) scheduling said task objects by each task object's requirement in said computer and reporting a task schedule via a user interface operatively connected to said computer.

2. A task management method according to claim 1 including one or more of the following sub-steps of:
a) alteration of said task information via said user interface,
such that a user is enabled to access directly or remotely said task information via said user interface, so as be able to alter task information and associated data;
(b) windowing capability of said user interface comprising:
a. a first windowing means for inputting task information to build said task objects from:
i. one or more templates of task information;
ii. imported task information; or
iii. de-novo, such that a task object is built from scratch;
b. a second windowing means for displaying said task schedule;
wherein said windowing capability is enabled to report output to a viewer;
c) sorting said task object's by ether one or combination of the following:
i. time and resource availability; then by
ii. priority(s), policy(s), rules(s), workflow(s) and dependency(s);
d) displaying tasks objects in a schedule wherein said task object by requirements are sorted;
e) scheduling said task objects into specified intervals such as daily or weekly schedules;
f) reporting said schedule of work on said user interface;
g) dating said schedule as one or more said task objects are completed;
h) generation new task schedules when one or more of the following occur:
a. said task information is altered including addition and removal;
b. said task objects are altered including addition, removal and completion;
i) assessment of said schedules, such that the generation of a new schedule is enabled to be accepted or rejected;
j) display within said user interface displays one or more task schedules as histogram(s);
k) analysis of said task objects according to:
a. an subjective estimate of said task requirements such that said task requirements as entered or adjusted by a user referred to as subjective estimates are analysed;
b. an objective evaluation of said subjective estimate's task requirements to re-calculate and re-allocate task requirements assigned to one or more task requirements; and
c. scheduling said task objects by task requirements contained in said subjective estimate and said objective evaluation, wherein subjective and objective schedules are reported.

3. A task management method according to claim 2 wherein said objective evaluation is performed by analysis of completed task information obtained from:
a. a log file associated with a user:
a) non-specifically; or
b) specified with one or more of the following:
i. completed task objects performed for specific client;
ii. completed task objects performed involving a specific team;
iii. completed task objects performed in a specified environment;
b. one or more log files from a plurality of users.

4. A task management method according to either claim 2 or claim 3 wherein said analysis is performed according to one or more of the following sub-steps of:
a. calculation of said objective evaluation using one or more of the following:
a) comparison of said task requirements of said subjective estimate to said completed task information's requirements, wherein:
(a) said comparison is based on one or more of the following:
a. said completed task requirements are in similar proportions to said subjective estimate task requirements enabling:
i. re-calculation of said task requirements into a ratio aligning said:
1. subjective estimate task requirements; with
2. completed task requirements; followed by
ii. re-allocation of task requirements in said task objects of said subjective estimate task requirements to form said objective evaluation;
(b) comparison of said subjective estimate to completed task information's metadata, wherein:
(a) said comparison is based on one or more of the following:
a. said completed task information's metadata has descriptors describing said task object to be similar as said subjective estimate enabling:
i. re-calculation of said subjective estimate's task requirements into a ratio aligning said:
1. subjective estimate task requirements; with
2. completed task requirements; followed by
ii. re-allocation of task requirements in said task objects to form said objective evaluation.

5. A task management method according to claim 2 or 3 wherein said analysis enables said objective evaluation's said task requirements to reflect completed task requirements using:
a. an algorithm derived from completed task requirements such that said subjective estimate's task requirements are adjusted where estimates have consistent estimation error(s).

6. A task management method according to claim 2 or 3 including the following sub-step of:
a. displaying tasks in a schedule wherein their said task object requirements are sorted as:
a) objective evaluations as analysed superimposed subjective estimate schedule as a Task Management Optimisation, followed by
b) subjective and objective schedules reported so as to enable the acceptance or the rejection of the Task Management Optimisation over the subjective estimate schedule.

7. A task management method according to claim 2 or 3 including one or more of the following sub-steps of:
1) windowing capability of said user interface comprising:
a. a first windowing means for inputting task information to build said task objects from:
i. one or more templates of task information;
ii. imported task information; or
iii. de-novo, such that a task object is built from scratch.
b. a second windowing means for analysis of one or more said task requirements via said subjective estimate said completed tasks log file(s), behavioural algorithms and/or normalised group data;
c. a third windowing means for displaying one or more subjective and/or objective task schedules;
wherein said windowing capability is enabled to report output such that a viewer can evaluate output.

8. A task management tool comprising:
a) a task information collection means including the following:
(i) task requirement data including one or more of the following:
i. time;
ii. resource,
iii priority;
iv. policy;
v. rules;
vi. workflow;
vii. dependency;
wherein said task requirement data define said task; and
(ii) metadata including one or more of the following:
i. task name(s);
ii. task goal;
wherein said metadata describes said task; and
b) task objects built from said task requirement data and associated metadata;
c) subjective and objective requirement data as analysed by one or more of the following:
(a) subjective estimates such that said task requirement data are entered as estimates by one or more users as associated with said metadata as subjectively acceptable to said user(s); and
(b) an objective evaluation performed through making an objective comparison(s) with one or more of the following:
a. past task information collection means such that past task requirement data are compared with like unfulfilled task requirement data;
b. a user's behavioural file(s) such that a user's behaviour is enabled to be compared with completed task requirement data;
c. behavioural algorithm output(s) wherein task object fulfillment is extrapolated from a user's behavioural file(s); and/or
d. normalised group data of like task information collection means wherein the application of said normalised group data is compared with like subjective task information collection means; and
such that said task information collection means is objectively evaluated against historic, external and/or extrapolated task information collection means; and
d) task objects schedule sort by each task object's requirement data wherein task schedule is reported via said user interface.

9. A task management tool according to claim 18 comprising:
a) task object(s) sorted by each, or by a combination, of the following:
i. time and resource availability; then by
ii. priority(s), policy(s), rules(s), workflow(s) and dependency(s).

10. A task management tool according to either claim 18 or claim 19 comprising:
a) a task information collection alteration means via said user interface,
such that a user is enabled to access directly or remotely said task information collection via said user interface, so as be able to alter task information.

11. A task management tool according to claim 8 or 9 comprising:
a) a visual reporting means of said user interface comprising:
a. a first windowing means for inputting task information collection means to build said task objects from:
i. one or more templates of task information collection means;
ii. imported task information collection means; or
iii. de-novo, such that a task object is built from scratch.
b. a second windowing means for displaying said task schedule;
wherein said visual reporting means is enabled to report output to a viewer.

12. A task management tool according to claim 8 or 9 comprising:
a) a schedule displaying task objects wherein said task objects are displayed as sorted by each said task object's task requirement data.

13. A task management tool according to claim 8 or 9 comprising:
a) daily or weekly schedules of said task objects.

14. A task management tool according to claim 8 or 9 comprising:
a) a user interface report.

15. A task management tool according to claim 8 or 9 comprising:
a) schedule update means as one or more of said task objects are completed.

16. A task management tool according to claim 8 or 9 comprising:
a. task schedule generation means resulting from said task requirement alteration including the addition, removal and completion of tasks objects such that new task schedules are generated when tasks are changed, abandoned or completed.

17. A task management tool according to claim 8 or 9 comprising:
a) schedule assessment, such that the generation of a new schedule is enabled to be accepted or rejected by a user.

18. A task management tool according to claim 8 comprising:
a) user interface histogram display such that one or more task schedules are displayed as histogram(s).

19. A task management tool according to claim 8 comprising:
a) analysis of said task objects according to:
a. an subjective estimate of said task requirement data such that said task requirement data as entered or adjusted by a user referred to as subjective estimates are analysed;
b. an objective evaluation of said subjective estimate's task requirement data to re-calculate and re-allocate task requirement data assigned to one or more task requirement data; and
c. scheduling said task objects by task requirement data contained in said subjective estimate and said objective evaluation, wherein subjective and objective schedules are reported.

20. A task management tool according to claim 19 wherein said objective evaluation is performed by analysis of completed task information collection means obtained from:
a. a log file associated with a user:
a) non-specifically; or
b) specified with one or more of the following:
i. completed task objects performed for specific client;
ii. completed task objects performed involving a specific team;
iii. completed task objects performed in a specified environment;
b. one or more log files from a plurality of users.

21. A task management tool according to either claim 19 or claim 20 wherein said analysis is performed according to one or more of the following sub-steps of:
a. calculation of said objective evaluation using one or more of the following:
a) comparison of said task requirement data of said subjective estimate to said completed task information collection mean's requirements, wherein:
(a) said comparison is based on one or more of the following:
a. said completed task information collection mean's requirements are in similar proportions to said subjective estimate enabling:
i. re-calculation of said task requirement data into a ratio aligning said:
1. subjective estimate task requirement data; with
2. completed task information collection mean's requirement; followed by
ii. re-allocation of task requirement data in said task objects of said subjective estimate task requirement data to form said objective evaluation;
b) comparison of said subjective estimate to completed task information collection mean's metadata, wherein:
(a) said comparison is based on one or more of the following:
a. said completed task information collection mean's metadata has descriptors describing said task object to be similar as said subjective estimate enabling:
i. re-calculation of said subjective estimate's task requirement data into a ratio aligning said:
1. subjective estimate task requirement data; with
2. completed task information collection mean's requirements; followed by
ii. re-allocation of task requirement data in said task objects to form said objective evaluation.

22. A task management tool according to claim 19 or 20 wherein said analysis enables said objective evaluation's task requirement data to reflect completed task requirement data using:
a. an algorithm derived from completed task requirement data such that said subjective estimate's task requirement data are adjusted where estimates have consistent estimation error(s).

23. A task management tool according to claim 19 or 20 comprising:
a. displaying tasks in a schedule wherein their said task object's requirements are sorted as:
a) objective evaluations as analysed superimposed on a subjective estimate schedule as a Task Management Optimisation, followed by
b) subjective and objective schedules reported so as to enable the acceptance or the rejection of the Task Management Optimisation over the subjective estimate schedule.

24. A task management tool according to claim 19 or 20 comprising:
1) a visual reporting means within said user interface comprising:
a. a first windowing means for inputting task information collection means to build said task objects from:
i. one or more templates of task information collection means;
ii. imported task information collection means; or
iii. de-novo, such that a task object is built from scratch.
b. a second windowing means for analysis of one or more said task requirement data via said subjective estimate said completed tasks log file(s), behavioural algorithms and/or normalised group data;
c. a third windowing means for displaying one or more subjective and/or objective task schedules;
wherein said visual reporting means is enabled to report output such that a viewer can evaluate output.

25. (canceled)

26. (canceled)
